(19) United States
(12) Patent Application Publication
(10) Pub. No.: US 2011/0125836 A1
(43) Pub. Date: May 26, 2011

(54) OPERATING SYSTEM

(76) Inventor: Denis McCarthy, County Kerry (IE)

(21) Appl. No.: 12/922,195

(22) PCT Filed: Mar. 4, 2009
(86) PCT No.: PCT/EP09/01612

§ 371 Date: Feb. 10, 2011

(30) Foreign Application Priority Data
Mar. 13, 2008 (GB) 0804703.7

(51) Int. Cl. G06F 15/16

(52) U.S. Cl. 709/203

(57) ABSTRACT

A data receiving system has a local terminal, a central processing facility and a communication system for allowing communication between the two. The local terminal communicates, using the communication system, with a server of the central processing facility to cause a hardware device of the terminal to capture data. The local terminal opens a communication link to the central processing facility; and calls a method on the server so that data captured by the hardware device is stored by the central processing facility.

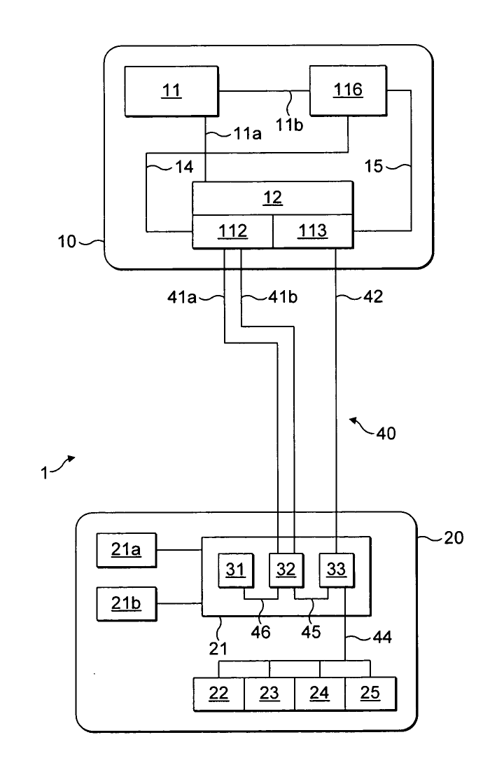

### FIELD OF THE INVENTION

The present invention relates generally to the field of data capture and receiving. Embodiments are concerned with secure data capture from remote locations. Some embodiments relate to data receiving and storage systems and methods that may be used in financial transactions.

Certain embodiments relate to access supervision, and more specifically but not exclusively to a terminal device and a method of operating a terminal device, for example in the field of payment for goods and services or currency exchange.

### BACKGROUND OF THE INVENTION

At present generally one method of securing data capture in the case of payment or currency exchange has a human operator who accepts cash or a card and in exchange provides a receipt in the case of payment, or issues cash in another currency. There is likely to be a set of rules that the human operator carries out, for example asking to see identity-confirming documents under certain circumstances.

In more recent approaches, an EPOS or EPOS-like terminal prompts the operator to follow rules. However, to date, automation of functionality of this type has been hindered by difficulties in communication and control that could allow an automated device to be vulnerable, for instance to fraud.

The present inventors have recognised that web browser technology can be used in coordination with either Internet or private-network communications in operating a terminal having different hardware devices that enable or facilitate financial transactions. To facilitate correct operation, and overcome potential problems caused by the limitations of automation, the inventor has devised interfacing technology to control the interaction of hardware with the communications software.

Embodiments of the invention may be regarded as a software ‘bridge’ to control cash-accepting hardware for financial transactions conducted via a web browser. The invention is not however restricted to software, but may be implemented in other ways to provide like functionality.

### SUMMARY OF THE INVENTION

In a general aspect, a system or method uses interactions between a remote device and a server process to capture data to a store remote from the data capture device. In some embodiments this uses webpages accessed at the remote device. In some embodiments a new connection is opened when data are to be captured, for example to allow for transfer of that data to or through the server process.

In one aspect there is provided a data receiving system comprising a local terminal, a central processing facility and a communication system for allowing communication between the local terminal and the central processing facility, wherein the local terminal comprises at least one user input device for selecting a desired terminal function and for inputting alphanumerical data and at least one hardware device selectively actuatable for capturing data, wherein the local terminal is configured to communicate, using the communication system, with a server process of the central processing facility, and the local terminal is configured to communicate captured data using the communication system to the central processing facility.

In another aspect there is provided a data receiving system comprising a local terminal, a central processing facility and a communication system for allowing communication between the local terminal and the central processing facility, wherein the local terminal comprises at least one user input device for selecting a desired terminal function and for inputting alphanumerical data and at least one hardware device selectively actuable for capturing data, wherein the local terminal is configured to render information from a server process of the central processing facility received over the communication system, and the local terminal is configured to communicate captured data using the communication system to the central processing facility.

In still another aspect there is provided a data receiving system comprising a local terminal, a central processing facility and a communication system for allowing communication between the local terminal and the central processing facility, wherein the local terminal comprises at least one user input device for selecting a desired terminal function and for inputting alphanumerical data and at least one hardware device selectively actuable for capturing data, wherein the local terminal has a browser client configured to communicate, using the communication system, with a server process of the central processing facility, wherein the local terminal is configured to open a communication link to the central processing facility so that data captured by the at least one hardware device is transferred using the communication system to the central processing facility.

In a more specific aspect there is provided a data receiving system comprising a local terminal, a central processing facility and a communication system for allowing communication between the local terminal and the central processing facility, the local terminal comprising at least one hardware device, and the central processing facility comprising a server and a store;

wherein the at least one hardware device is selectively actuated for capturing data,
wherein the local terminal is configured to communicate, using the communication system, with a server of the central processing facility, and to cause the at least one hardware device to capture data;
wherein the local terminal is configured to open a communication link to the central processing facility;
wherein the local terminal is configured to call a method on the server so that data captured by the at least one hardware device is stored by the central processing facility in the store.

In an embodiment, the local terminal comprises a display, and the local terminal runs browser software for rendering to the display data received from the server. The browser may for instance use http; it may also be able to supply data to the server.

In an embodiment, the local terminal comprises a user input system for selecting between plural terminal functions. This may comprise a touch screen, a user pointing device for interaction with a GUI, or fixed keys, for example.

In an embodiment, the local terminal comprises a user input system for inputting alphanumeric data. This may comprise a touch screen, a keyboard, or a card reader, for example.

In an embodiment the at least one hardware device comprises one or more from the list comprising a passport reader, a camera, a fingerprint scanner, a retinal scanner, a bill acceptor, a coin acceptor, passport optical swipe reader, document scanner, chip-and-pin credit card readers, VOIP telephone device.

The local terminal may further comprise a printing device. Such a printing device may in some embodiments be configured to print data indicative of alphanumeric data that was input during use, for example to provide receipts, or to print tickets. Alternatively, or as well, such a printing device may be responsive to information received by the local terminal from the server. In this way, an indication that some successful processing at the server has taken place may cause or affect printing.

In another aspect there is provided a method of operating a data receiving system comprising a local terminal, a central processing facility and a communication system for allowing communication between the local terminal and the central processing facility, the local terminal comprising at least one hardware device, and the central processing facility comprising a server and a store; the method comprising:—causing the local terminal to communicate, using the communication system, with the server of the central processing facility; in response thereto, actuating the at least one hardware device to capture data; the local terminal opening a communication link of the communication system to the central processing facility, and calling a method on the server, whereby data captured by the at least one hardware device is transferred to and stored by the central processing facility in the store.

In a yet further aspect there is provided a method of enabling a user transaction comprising receiving data indicative of a user at a terminal; requiring identity-confirmative data to be input to the terminal; activating a hardware device to cause the identity-confirmative data to be captured; transferring the captured data to a processing facility; processing the captured data to determine user identity; and transferring a message to the terminal to allow the transaction to proceed.

In this method, in response to user input, web page data from the processing facility may be at the terminal using browser functionality, and the transferring step may use web services functionality.

In a related aspect there is provided a method of operating a financial services terminal, comprising electronically transferring data related to transactions of the terminal to a central processing facility, processing data received at the central processing facility and polling a database of the central processing facility.

The method may comprise inhibiting at least a part of the terminal device in response to the polling step.

In another related aspect there is provided a method of carrying out a financial transaction between two currencies, comprising inputting user-identifying data at a terminal; automatically transferring the data to a central database; checking the data; in response to a successful check, automatically enabling a user at the terminal to input cash in a first currency to the terminal; storing the amount of input cash in an entry in the central database, and enabling a recipient to access an amount of cash in a second currency related to the entry in the central database.

There is also provided a method of operating a terminal device having at least one hardware device, in concert with a server, the method comprising:—causing a web browser program of the terminal device to navigate to a URL at the server, associated with the selection, thereby to receive and render a response received from the server; and to communicate to a hardware control application; in response to such communication, the control application: activating the hardware device to perform an action, reading a parameter returned from the web browser; and opening a new communication channel between the hardware control application and the server, independent of the connection between the web browser and the server; the control application receiving a response from the hardware device, and saving the response to the server over the new communication channel.

### BRIEF DESCRIPTION OF THE DRAWING

An exemplary embodiment will now be described with reference to the accompanying FIGURE, which shows a block diagram of a financial transaction system embodying the invention.

### DETAILED DESCRIPTION

Referring to the FIGURE, a block diagram of a financial transaction system 1 has two main parts, a central processing part 10 and one or more remote parts 20. The two parts 10 and 20 are shown as connected via a communication system, here a VPN (Virtual Private Network) 40. The VPN in this embodiment makes use of the Internet as its “carrier”, to provide a highly secure transmission system tunnelling through the Internet. It will however be appreciated that a true private network is equally possible, where available. Such systems could for instance use a leased line or leased channel.

The central processing part 10 includes a computer system running an operating system and supporting a business application 11 and a web server application 12. The business application 11 has a number of rules for carrying out the businesses process related in this embodiment to financial transactions, and also for supervising data handling operations. It may communicate over a communications path 11a with the web server, may access the database 116 via a communications path 11b, and may communicate with external systems, as required. It may for example be capable of communicating with an external computer system such as a cash-dispensing agent in a foreign country. The web server application 12 supports two functionalities, a browser function 112 and a web services function 113. The browser function 112 and the web services function 113 are each connected via respective two-way communication links 14, 15 to a database 116, shown in this embodiment as part of the central part 10. It will be noted that these links may be made as required or may be constant.

The remote part 20 in this embodiment is a foreign exchange kiosk. It includes a computer device 21, a display 21a, a user input device 21b and plural hardware devices, in this embodiment a passport reader 22, a coin acceptor 23, bill acceptor 24 and a camera 25. The user input device 21b may be a physical set of keys associated with the display, or touch-screen keys on the display or displayed keys of a GUI, actuated by a pointer device such as a mouse or tracker ball, or both.

The computer device 21 has an operating system and runs three groups of applications, a kiosk application 31, a web browser application 32 and a hardware control application 33.

The kiosk application 31 contains a number of rules for operating the kiosk 20. Mostly these are low-level functional rules that are resident in the kiosk to avoid unnecessary communication with the server. The kiosk application 31 is also responsible for effecting operation of at least some of the hardware devices 22-5, for example firing up the camera, via a connection (not shown).

The browser application 32 has an http connection 41 over the communication network 40 to the http server 112. This connection is figuratively shown as having a first path 41a from the http server 112 to the browser application 32, and a second path 41b from the browser application 32 to the http server 112. The hardware control application 33 has a connection 42 to the web services function 113. The connection 42 may be a permanent channel, or a secure channel invoked as required, for example using SSH. The hardware control application 33 also has respective connections to each hardware device 21-25; these connections may be physically separate connections to each device or may be another suitable arrangement, for instance a bus connection 44, as shown, capable of logically separate control of each device. The kiosk computer system contains a logical communication path 45 for two way message communication between the browser 32 and the hardware controller application 33, a like path 46 for two-way communication between the kiosk application 31 and the browser 32.

Over the connection 41 what are transferred between the client and the server are simply requests from the browser, followed by corresponding responses from the server. These responses are then used to render content on the browser screen (so far, so typical of 99.99% of all web sites and browsers). The separate communication channel 42 is used in order to ensure the normal browser-server channels are undisturbed, both in time terms, and also in functional terms. In other words the browser-web server communication is not interrupted by other signals, and is not required to be something other than what it is designed to be conventionally. However, the kiosk has extra requirements, namely the need to physically interact with its own hardware.

An example of the kiosk of the embodiment in use will now be described.

A user in a first country (say, Germany) wishing to pass money to an account for a third party in a second country (say, USA) different to the first, with the first and second countries having different currency systems. The user approaches the kiosk, and is presented with a screen displaying a message offering a language selection. In this embodiment the screen is a touch screen, and upon the user touching the screen to select one of the displayed language options, the kiosk application 31 selects the required data set for the selected language, say, English. In this embodiment this is achieved by the kiosk application 31 instructing its browser 32 to contact the remote server 112, which then returns page information rendered by the browser 32 to include a number of buttons each with an associated option. Options other than “transfer money” may include, for example, one or more of “pay for goods”, “pay bill”, “purchase airline ticket”, “purchase insurance”; “view available agents”, “pay for good purchased on the Internet” and “mobile phone top-up”. (This list is exemplary, and by no means exhaustive). Touching any of the buttons selects a respective different URL, from a set of locally-stored URLs, and causes the kiosk application 31 to direct the browser 32 to the selected URL at the server 112. The server in turn returns the data from that URL to the browser 32, which renders that data as a corresponding display at the kiosk.

In other embodiments, the language selection may be effected locally by the kiosk application 31, with the kiosk application selecting locally-stored text for each different language for each button. In yet other embodiments, no language selection is needed as icons are used to indicate the options; in still others, only a single language is displayed.

Hence upon the user touching the “transfer money” button, the effect is that a screen relevant to money transfer functionality is displayed. In this embodiment the screen includes buttons for “pay by cash” and “pay by card”.

For our example, the user wishes to transfer money by paying, into the kiosk, cash in Euros to enable the third party to access funds in dollars. Hence the user touches the corresponding button, which selects a corresponding URL which is passed by the kiosk application to direct the browser 32 to that URL at the server 112. The server 112 returns data at the URL which data are rendered to the kiosk screen to present fields for completion by the user. These include, in this embodiment, the name and address of the user, the name and other identifying information of the third party and the amount of money to be transferred. When this information is complete, the user has a “next” button on the screen. Touching this “next” button, causes the data input to the form fields to be sent by the browser 31 to the server 112, and to be stored in fields of the database 116.

In this embodiment, a check is made at the server 112 on the amount data, to determine if it is above a set threshold, for example 500 Euros. If the amount is above the threshold, the kiosk software 31 passes information to the browser 32 and thus to the server 112 indicating that security steps are to be taken. In other embodiments the decision on security may be taken at the server 112 which returns data to the browser instructing the browser to cause security steps to be taken; in yet others the security steps are always taken by the kiosk software 31, or are taken randomly on amounts below the threshold as well as on amounts above the threshold.

In this example, the user wishes to transfer 1000 Euros, which is above the threshold. The browser 32 is supplied with a URL that causes the server 112 to respond by returning data corresponding to a blank page, and the kiosk application 31 fires up the camera 25. A moving image picked up by the camera 25 is shown in a window on the screen, along with text inviting him/her to take a picture when ready. This is provided by the kiosk application 31 outputting data rendered by the browser 32 as a GUI.

Once the customer takes a picture, the browser 32 communicates with the hardware control application 33 to open up a new connection. Examples of this could be over http, ssh or the like. In the present embodiment, remote method invocation (RMI) over http is used. The browser 32 then calls a remote method on the server 12 using this connection to save the user's picture to the database 116, associating it with the correct transaction using session management techniques.

Once this is done, the kiosk application 31 instructs the browser 32 to advance the page the user is viewing to a next page (because the photo has been taken and the customer can proceed).

The communications between the browser 32 and the server 112 is entirely separate from the hardware controller's communications with the server 113. In an embodiment the browser 32 is an embedded version of Firefox, which looks after creating its own requests, and rendering the responses. In this embodiments the hardware controller 33 sets up its own communications link (at the moment over http) with the server that it uses to send data to the server. Again in this embodiment the communication link 42 is one way—from the client to the server—the server does however respond to requests from the client, although it never initiates requests.

The next page, in this example, causes the server to return data instructing the browser 32 and kiosk application 31 to activate the passport reader 22, to display text instructing the user to place his/her passport in the reader 22, and to display a window showing what is currently in the passport reader 22, along with a button for “read”. When the user is satisfied with the image in the current window, he/she touches “read”.

The touching of the “read” button causes the browser 32 to communicate with the hardware control application 33 to open a new connection, if a connection is not already open and to call a remote method on the server 112 to save the passport scan to the database 116 using the web services link, as before with the picture. A reconciliation of the passport picture and the picture from the camera is then carried out, to determine whether the user and the passport holder are the same person. In some embodiments a new connection is always opened.

If the reconciliation is successful, then a flag associated with the current transaction entry in the database 116 is set; until the reconciliation is complete, the flag remains unset.

In the meantime, the kiosk application 31 polls the database 116 at intervals, for example every second, to determine whether the flag corresponding to the current transaction for the kiosk has been set, or not. If after a time period set by the kiosk itself no flag has been set, the transaction is aborted. However if, before this time-out period has elapsed, the flag is set, the kiosk application 31 supplies a new URL to its browser 32 and activates the bill acceptor 24 via the hardware control application, which opens a new connection with the server 112 for web services communication, if one is not already open. The server 112 returns a blank page, and the kiosk application provides data rendered to the display instructing the user to input bills to the bill acceptor and showing the amount rendered, initially zero. Then, as the user inputs bills to the bill acceptor 24, the bill acceptor checks each bill and passes the relevant amount to the kiosk application 31. This, in turn, updates the display and at the same time passes the amount of the current bill via the web services communication channel to the database 116 in real-time. The web services channel is generally one-way, as has previously been mentioned but includes exception handling techniques to ensure proper communication has occurred.

If a coin acceptor is provided, this may be activated at the same time to enable coins to be deposited.

The hardware controller 33 keeps tally on the amount deposited and compares against the required amount, in this embodiment obtained by reading data on the browser's current page as a hidden field. In some embodiments, it may instruct a cash dispenser to make change. Once the required amount has been deposited, the hardware controller 33 accesses the server 112 via a web service and updates the transaction database entry. It also instructs the browser 32 to advance to an URL indicative of “this transaction OK”, which causes the server 112 to return data rendered as the next screen. This screen displays, in this embodiment, a button for “transactions complete” and a button for “further transaction”. If the user touches the “transactions complete” button, the browser 32 returns to the opening URL while the kiosk application 31 forwards information to a printer BB which then prints a receipt for the user. If the user touches the “further transaction” button, the process iterates. In iterations after the first, security steps may be omitted. Alternatively, if for example no security steps were taken for the first transaction (since it was below the threshold) security steps may be taken on a subsequent iteration in which the threshold was exceeded, or if a total of transaction exceeded the threshold or another threshold.

The database 116 in this embodiment includes fields for transactions and sessions. The database also includes entries for kiosk identifiers, and to indicate fullness of bill acceptors at the associated kiosk. A hardware controller 33 communicates with the database 116 in this embodiment to indicate if it senses the bill acceptor 24 is full, and the server 112 then will only return URLs enabling non-cash transactions at the relevant kiosk.

Rules in supervisory systems examine transactions at kiosks by reference to unusual activity, or known problem patterns, and processes in the server software set flags in the kiosk identifier entries in the database 116. In this embodiment, each kiosk polls for flags set in its database entries at intervals or at the start of each transaction, or both, and acts accordingly—for example to disable the kiosk.

This embodiment also provides for different levels of security to be invoked according to perceived trustworthiness of the user concern. A regular user may have a card that may be read by the kiosk and, in concert with a personal identification number, may allow a higher threshold to be imposed before security steps are invoked.

Other embodiments of the invention may be applied to financial systems—e.g. payment systems other than foreign exchange, and to other access control systems than financial systems.

Payment systems include, for example, purchase of catalogue items, purchase of airline tickets, phone credits, prize bonds and the like. For example, an intended purchaser may not have a credit card, or not have access to a credit card but have cash to pay for the item and be at a remote location. Systems embodying the invention may allow the intended purchaser to pay either in the currency of the item to be purchased or in another currency, with the merchant receiving confirmation from the system and able to confirm the identity of the intended purchaser.

The ability of systems embodying the invention to automatically input and hold security information, such as photographs, fingerprints, retinal scans is useful in a variety of access control situations, as the use of the web services channel enables this information to be passed to a database in real-time. Checking of correspondence of photographs with passport information may be effected at the remote location automatically, or by a human operator.

The invention is not restricted to the features of the described embodiment but instead extends to the full scope of the appended claims.

1. A data receiving system comprising a local terminal, a central processing facility and a communication system for allowing communication between the local terminal and the central processing facility, the local terminal comprising at least one hardware device, and the central processing facility comprising a server and a store; wherein the at least one hardware device is selectively actuated for capturing data, wherein the local terminal is configured to communicate, using the communication system, with the server of the central processing facility and to cause the at least one hardware device to capture data; wherein the local terminal is configured to open a communication link to the central processing facility; wherein the local terminal is configured to call a method on the server so that data captured by the at least one hardware device is stored by the central processing facility in the store.

2. A data receiving system according to claim 1, wherein the local terminal comprises a display, and the local terminal runs browser software for rendering to the display data received from the server.

3. A data receiving system according to claim 2, wherein the local terminal comprises a user input system for selecting between plural terminal functions

4. A data receiving system according to claim 2, wherein the local terminal comprises a user input system for inputting alphanumeric data.

5. A data receiving system according to claim 1, wherein the at least one hardware device comprises one or more from the list comprising a passport reader, a camera, a fingerprint scanner, a retinal scanner, a bill acceptor, a coin acceptor, passport optical swipe reader, document scanner, chip-and-pin credit card readers, VOIP telephone device.

6. A data receiving system according to claim 1, wherein the local terminal further comprises a printing device.

7. A data receiving system according to claim 6, wherein the printing device is configured to print data indicative of alphanumeric data that was input during use.

8. A data receiving system according to claim 1, wherein the printing device is responsive to information received by the local terminal from the server.

9. A method of operating a data receiving system comprising a local terminal, a central processing facility and a communication system for allowing communication between the local terminal and the central processing facility, the local terminal comprising at least one hardware device, and the central processing facility comprising a server and a store; the method comprising:—
causing the local terminal to communicate, using the communication system, with the server of the central processing facility;
in response thereto, actuating the at least one hardware device to capture data;
the local terminal opening a communication link of the communication system to the central processing facility, and calling a method on the server, whereby data captured by the at least one hardware device is transferred to and stored by the central processing facility in the store.

10. A method of enabling a user transaction comprising
receiving data indicative of a user at a terminal;
requiring identity-confirmative data to be input to the terminal;
activating a hardware device to cause the identity-confirmative data to be captured;
transferring the captured data to a processing facility;
processing the captured data to determine user identity; and
transferring a message to the terminal to allow the transaction to proceed.

11. A method according to claim 10, further comprising,
in response to user input, rendering web page data from the processing facility at the terminal using browser functionality, wherein the transferring step uses web services functionality.

12. A method of operating a financial services terminal, comprising electronically transferring data related to transactions of the terminal to a central processing facility, processing data received at the central processing facility and polling a database of the central processing facility.

13. A method according to claim 12, comprising inhibiting at least a part of the terminal device in response to the polling step.

14. A method of carrying out a financial transaction between two currencies, comprising inputting user-identifying data at a terminal; automatically transferring the data to a central database; checking the data; in response to a successful check, automatically enabling a user at the terminal to input cash in a first currency to the terminal; storing the amount of input cash in an entry in the central database, and enabling a recipient to access an amount of cash in a second currency related to the entry in the central database.

15. A method of operating a terminal device having at least one hardware device, in concert with a server, the method comprising:—
causing a web browser program of the terminal device
to navigate to a URL at the server, associated with the selection, thereby to receive and render a response received from the server; and
to communicate to a hardware control application;
in response to such communication, the control application:—
activating the hardware device to perform an action,
reading a parameter returned from the web browser; and
opening a new communication channel between the hardware control application and the server, independent of the connection between the web browser and the server;
the control application receiving a response from the hardware device, and saving the response to the server over the new communication channel.
